(19) United States
(12) Patent Application Publication
(10) Pub. No.: US 2018/0353363 A1
(43) Pub. Date: Dec. 13, 2018

(54) MARYED HEALTHCARE SOLUTION BED

(71) Applicant: Ngozi Moneke, Freeport, NY (US)

(72) Inventor: Ngozi Moneke, Freeport, NY (US)

(21) Appl. No.: 15/731,428

(22) Filed: Jun. 9, 2017

(51) Int. Cl. A61G 9/00; A61G 7/015; A61G 7/02

(52) U.S. Cl. CPC A61G 9/003; A61G 7/05776; A61G 7/02; A61G 7/015

(57) ABSTRACT

According to at least one embodiment, an apparatus for continuous collection of human waste products is disclosed. The apparatus may include a bed frame, a lower plate having a container coupled thereto, an upper plate having an aperture defined therein, a mattress having an aperture defined therein, a mattress cover having an aperture defined therein and an absorbent pad having a bag coupled thereto. The apparatus may allow for continuous collection of human waste products while maintaining the patient in a comfortable position. The apparatus may further facilitate preventing human waste products from contacting the skin of the patient, thereby Substantially reducing the occurrence of pressure ulcers. Additionally, the apparatus may reduce the need for the use of Foley catheters for incontinence management, thereby reducing the occurrence of urinary tract infections related to Such SC.

### BACKGROUND OF THE INVENTION

### Field of the Invention

The inventive device disclosed in the present application generally relates to hospital beds and more specifically to a patient bed with a build-in bedpan. The commonly refers to it as the MaryEd Healthcare Solution Bed.

### Brief Description of the Prior Art

Hospital beds with built-in bedpans are well known in the art. For example, U.S. Pat. No. 5,685,034 to Kleer et al. discloses and claims a hospital bed that includes a frame assembly having a two-part mattress support comprised of a head mattress support and a foot mattress support, with the head mattress support including a head portion and a horizontal ramp articulated to one another, and with the foot mattress support including an front portion and a rear portion articulated to one another. The head mattress support of the Kleer et al. invention is movable in a horizontal direction relative to the foot mattress support and tiltable in a vertical direction while the front portion of the foot mattress support is tiltable in a vertical direction, with the rear portion of the foot mattress support movable between outer and inner positions to allow formation of an opening when the rear portion of the foot mattress support is moved to inner position. An upwardly open toilet pan which is supported by the frame assembly is movable in position for vertical registry with the opening when the rear portion of the foot mattress support occupies the inner position.

In addition to that, U.S. Pat. No. 5,926,875 to Okamoto and Nakayama discloses and claims a bed, in combination with a flush toilet, has a bed body provided with an opening. The opening has a width, which is sufficient to accommodate the hips of a sick or disabled person laying on the bed. The opening can be opened and closed by a cover. The cover of the Okamoto and Nakayama patent can be withdrawn from a retracted (open) position where it is accommodated on the back of the bed body to close the opening. A flush toilet is disposed below the opening. Additionally under the teachings of Okamoto and Nakayama toilet seat is disposed in the opening and has a somewhat cylindrical excreta guide for reliably guiding excreta into the flush toilet. The toilet seat can be tilted about a vertical axis by a lift. Also, the toilet seat free end is tilted upward so as to be in close contact with the hips of the sick or disabled person.

U.S. Pat. No. 6,848,133 to Tanaka also discloses and claims a care bed comprises a bed main body provided with an opening for elevating a bedpan, a bedpan assembled downward of the bed main body and supported in a freely elevating manner with respect to the bed main body, a bedpan elevating device that is moved between a lifted position in which the bedpan is lifted through the opening of the bed main body to above the bed surface and a descended position in which it is stored under the bed main body, and an excrement collecting device for sucking and collecting excrements from the bedpan.

U.S. Pat. No. 5,513,404 to Kanai discloses and claims an invention that enables a bedridden person to perform excretory functions without help from another person. The invention disclosed by Kanai includes a bed and a movable toilet in which water is provided. A negative pressure propels water and excrements through a bottom hole in a lower part of the toilet, through a valve and to a sanitary container.

U.S. Pat. No. 4,821,348 to Pauna discloses and claims a combination bed, toilet, and bath for handicapped person includes a tub with a built-in toilet. Inflatable air bags or cushion are used to raise and lower the patient between resting positions and toilet and bathing positions.

Finally, U.S. Published Patent Application No. 20140068862 to Al-Jafar discloses a bed with an integral toilet includes a frame, a mattress and a support for supporting the mattress on the bed frame. The mattress and support define an opening extending through the mattress and support. Under the teachings of the Al-Jafar application robotic system removes and replaces a cushion for filling the opening and for replacing the toilet in alignment with the opening. An integral bidet, a source of clean water, a nozzle, a variable speed pump and mechanism for connecting a source of water to the bidet are included. A second opening in a lower portion of the toilet is connected to a waste storage tank. An odor eliminator is provided and a remote control allows a patient to control the unit.

Despite all the efforts listed above prior art patents describe structures that are either not truly convenient or else involve complicated, expensive, and overly difficult assembly and/or disassembly parts and procedures. Other devices have been advertised on various media but never patented or described into a printed publication.

### SUMMARY OF THE INVENTION

The invention is a patient bed with a build-in bedpan. A section of the mattress may be removed manually or the mattress may move automatically to reveal the bedpan.

It is then the principal object of the present invention is to provide a way for patients to use bedpans conveniently, without needing assistance for getting out of bed and walking to the bathroom, especially when getting out of bed is contraindicated. It is a secondary objective of the present invention to a device that will eliminate the need for the patient to use a regular bedpan with hard surface, which is often described by patients as being very uncomfortable, painful, and embarrassing.

It is an additional objective of the present invention to provide a device that does not rusts or deteriorate over time and that can be safely installed in a hospital setting. It is a final objective of the present invention to provide for a device that is relatively inexpensive to build and set up, but can eventually be sold at a premium.

These and other objective achieved by the device of the present invention will be apparent by the drawings, by their detailed description, and by the specification here from appended.

### BRIEF DESCRIPTION OF THE DRAWINGS

FIG. 1 is a perspective view of “MaryEd Healthcare Solution Bed” in accordance with the teaching of the present invention.

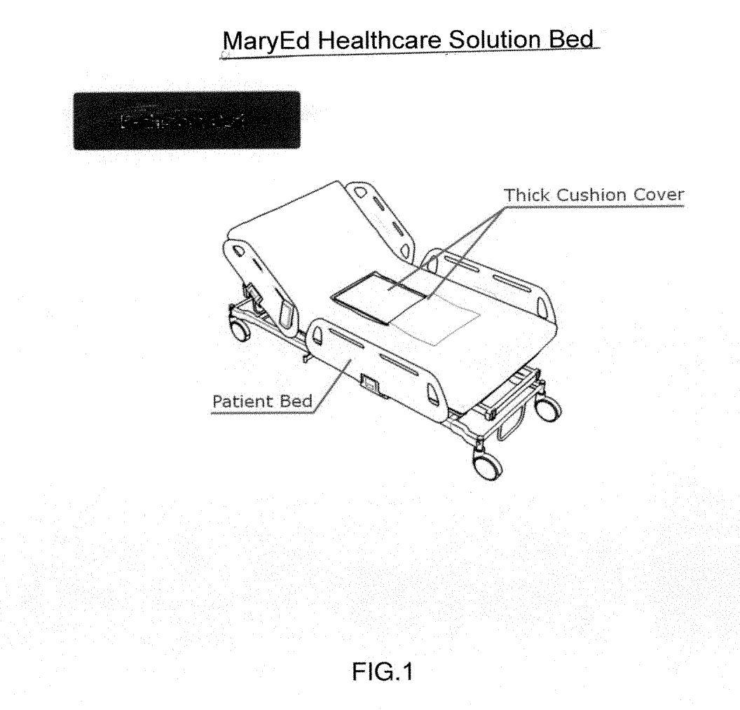

FIG. 2 is a top perspective view of “MaryEd Healthcare Solution Bed” of FIG. 1 and all its features.

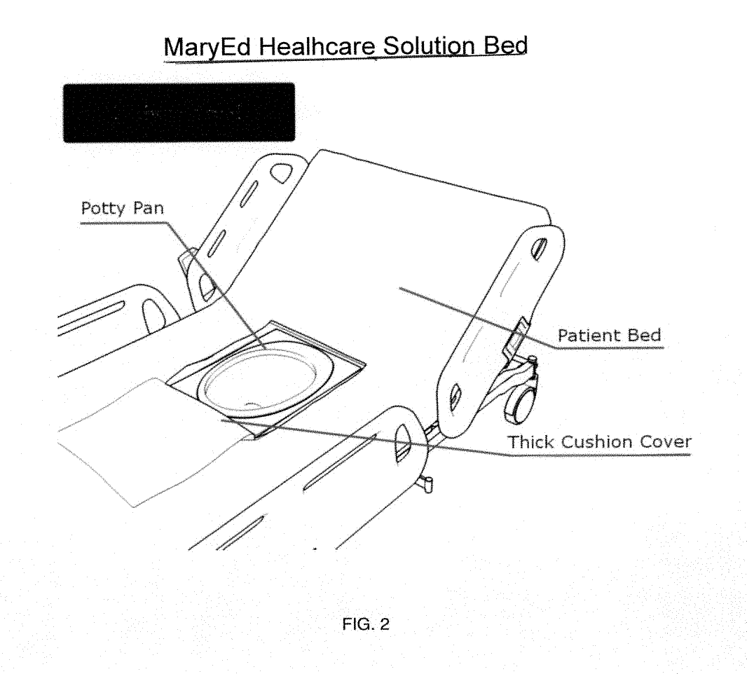

FIG. 3 is a perspective view of “MaryEd Healthcare Solution Bed” of FIG. 1.

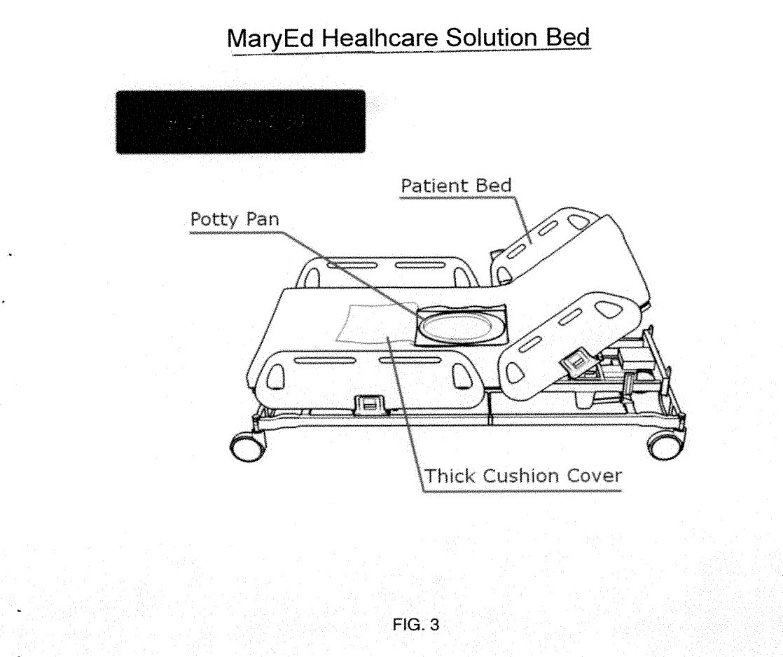

### DESCRIPTION OF THE PREFERRED EMBODIMENT

The invention is a patient bed with a build-in bedpan. A section of the mattress may be removed manually or the mattress may move automatically to reveal the bedpan. As it can be inferred from the drawings essential components of the “MaryEd Healthcare Solution Bed” of the present application include: a thick cushion cover, a potty pan, and a patient bed.

The MaryEd Healthcare Solution Bed is a revolutionary new bed for patients. It is fully adjustable with side bars, like standard beds found in hospitals and other patient care facilities. In addition, this bed has a built-in bed pan that can be accessed easily so the patient does not have to be assisted in and out of their bed when needing to use a toilet. The manual version of this bed has a cushion covering the opening to the bed pan. When this is removed, the patient can sit over the bedpan.

An automated version of the bed is also envisioned. It operates electrically and when the appropriate button is pushed, the mattress separates in the middle to expose the soft surface of the bedpan. After it is used, a button can be pushed to move the two sides of the mattress back to a closed position. The soiled bedpan can be accessed from the side of the bed for cleaning and then replaced the same way. At some point, when it is determined that the patient's bed does not have to be moved, it may be possible to connect the bedpan to a sewer system, so it can be rigged up to “flush,” eliminating the need to empty the used bedpan manually.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. The invention is a patient bed with a built-in bedpan. A section of the mattress may be removed manually or the mattress may move automatically to reveal the bedpan. The commonly refers to it as the MaryEd Healthcare Solution Bed. It is emphasized that this claim is provided to comply with the rules requiring a claim that will allow a searcher or other reader to quickly ascertain the subject matter of the technical disclosure.
